(19) United States
(12) Patent Application Publication
(10) Pub. No.: US 2014/0176470 A1
(43) Pub. Date: Jun. 26, 2014

(54) ELECTRONIC DEVICE AND METHOD FOR AVOIDING MISTOUCH ON TOUCH SCREEN

(71) Applicants: Chiun Mai Communication Systems, Inc., New Taipei (TW); SHENZHEN FUTAIHONG PRECISION INDUSTRY CO., LTD., Shenzhen (CN)

(72) Inventor: FEI HUANG, Shenzhen (CN)

(73) Assignees: Chiun Mai Communication Systems, Inc., New Taipei (TW); SHENZHEN FUTAIHONG PRECISION INDUSTRY CO., LTD., Shenzhen (CN)

(21) Appl. No.: 14/132,765

(22) Filed: Dec. 18, 2013

(30) Foreign Application Priority Data
Dec. 26, 2012 (CN) 2012105738268

(51) Int. Cl. G06F 3/041

(52) U.S. Cl. CPC G06F 3/0416
USPC 345/173

(57) ABSTRACT

In a method for avoiding mistouch on a touch screen of an electronic device, one or more specified regions on the touch screen is preset to avoid mistouch. In response to receiving a touch signal in the specified regions, the method determines whether a single-touch operation or a multi-touch operation is implemented. When a multi-touch operation is implemented, the touch signal received from the specified regions is ignored, and a response to touch signals received from non-specified region is executed. When a single-touch operation is implemented, a response to the touch signal received from the specified regions is executed.

### BACKGROUND

1. Technical Field

Embodiments of the present disclosure relate to touch screen technology, and particularly to an electronic device and method for avoiding mistouch on a touch screen.

2. Description of Related Art

More electronic devices are having large touch screens. To enlarge a touch screen, some manufacturers decrease the frames of the electronic device around the touch screen. Thus, when a user holds the electronic device by hand to operate the touch screen, mistouch easily occurs on specified regions of the touch screen that are close to the frames of the electronic device. For example, the user's hand overlays the specified regions of the touch screen when the user implements a single-touch operation on the touch screen, the single-touch operation is determined to be a multi-touch operation on the touch screen, thus a mistouch occurs on the touch screen. Accordingly, it is difficult to avoid mistouch on the touch screens. Therefore, an improved method for avoiding mistouch on a touch screen is desired.

### BRIEF DESCRIPTION OF THE DRAWINGS

FIG. 1 is a block diagram of one embodiment of an electronic device including a management system.

FIG. 2 is a schematic diagram of a touch screen of the electronic device.

FIG. 3 is a flowchart of one embodiment for avoiding mistouch on a touch screen using the management system.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

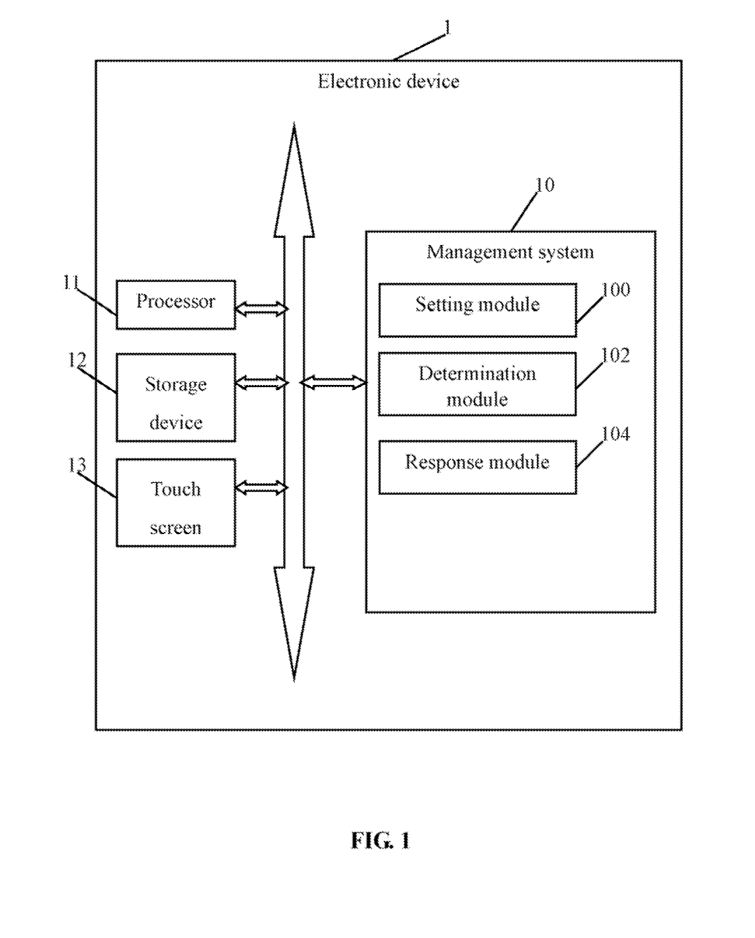

FIG. 1 is a block diagram of one embodiment of an electronic device 1 including a management system 10. The electronic device 1 may be a mobile phone, a tablet computer, a personal digital assistant, a notebook computer, or other computing device. The electronic device 1 further includes at least one processor 11, a storage device 12, and a touch screen 13. FIG. 1 illustrates only one example of the electronic device 1 that may include more or fewer components than illustrated, or have a different configuration of the various components.

The at least one processor 11 is used to execute the management system 10 and other applications, such as an operating system, installed in the electronic device 1. The storage devices 12 store one or more programs, such as the operating system and applications of the electronic device 1. The storage device 12 can be a storage card, such as a memory stick, a smart media card, a compact flash card, a secure digital card, or any other type of memory storage device.

The touch screen 13 may display visible data and receive touch signals in response to touch operations.

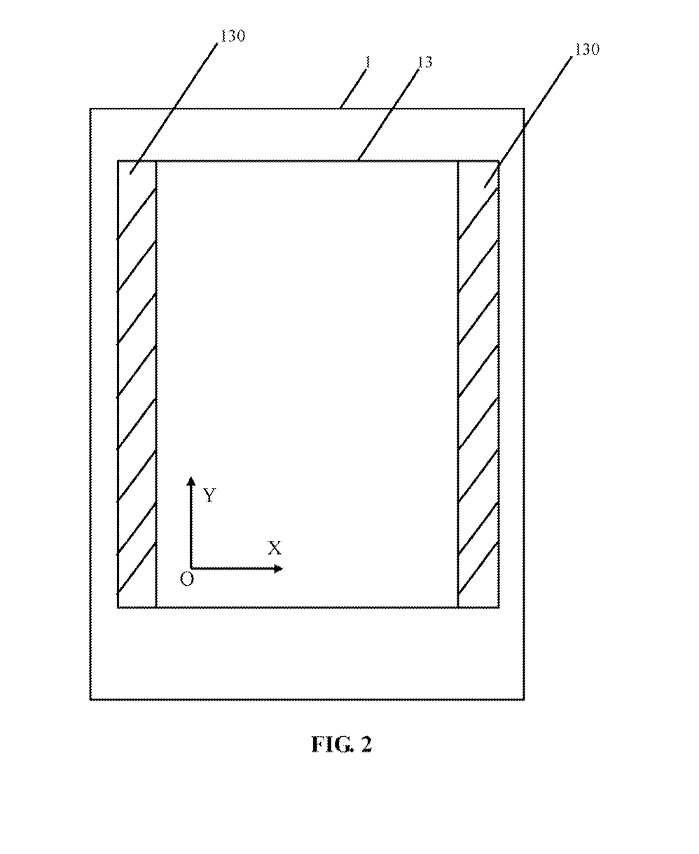

In some embodiments, the management system 10 may preset one or more specified regions (e.g., regions 130 as shown in FIG. 2) on the touch screen 13 to avoid mistouch occurring on the specified regions. When the management system 10 determines that a multi-touch operation is implemented by a user of the electronic device 1, the management system 10 ignores touch signal received from the specified regions, or outputs a prompt to ask the user whether to execute the multi-touch operation or not.

In one embodiment, the management system 10 may include one or more modules, for example, a setting module 100, a determination module 102, and a response module 104. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

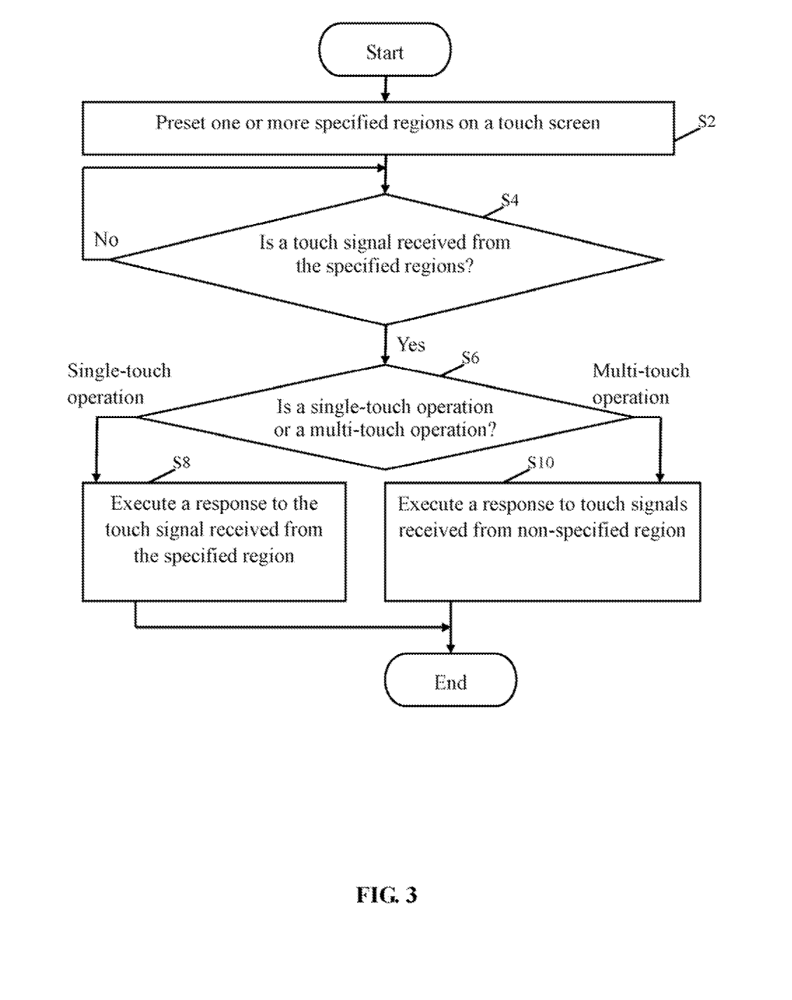

FIG. 3 is a flowchart of one embodiment for avoiding mistouch on the touch screen 13 using the management system 10. Depending on the embodiment, additional steps may be added, others removed, and the ordering of the steps may be changed.

In step S2, the setting module 100 presets one or more specified regions on the touch screen 13 to avoid mistouch occurring on the specified regions. The setting module 100 predetermines a coordinate system based on the touch screen 13, and presets coordinate ranges of the specified regions.

FIG. 2 shows a schematic diagram of the touch screen 13. In FIG. 2, two regions 130 are preset to be the specified regions, which are close to frames of the electronic device 1 to avoid mistouch when the user holds the electronic device 1 by hand. In other embodiments, the specified regions may be preset anywhere on the touch screen 13 according to user requirements.

In some embodiments, the setting module 100 may preset the specified regions by the following steps. The setting module 100 determines a length and a width of the touch screen 13 according to a resolution of the touch screen 13, and then determines a length and a width of the specified regions. For example, as mentioned above, the specified regions as shown in FIG. 2 are close to the frames of the electronic device 1. The setting module 100 presets the length of the two specified regions (e.g., the regions 130) to be equal to the length of the touch screen 13, and presets the width of the two specified regions to be equal to a predetermined percentage of the width of the touch screen 13.

It is assumed that the predetermined percentage is P%, and the width of the touch screen 13 is W, an origin of the coordinate system is a bottom left vertex of the touch screen 13. The width of the touch screen 13 is determined to be an X axis, and the length of the touch screen 13 is determined to be a Y axis. Thus, the setting module 100 may preset an X coordinate range of one region 130 on the left of the touch screen 13 to be (0, W*P%), and preset an X coordinate range of one region 130 on the right of the touch screen 13 to be (W*(1−P%), W). The predetermined percentage may be modified according to user requirements.

The setting module 100 further records the coordinate range of the specified regions in a board support package (BSP) layer of the electronic device 1. Thus, the operating system and other layers of the electronic device 1 may identify touch operations of the user according to the preset specified regions.

In step S4, the determination module 102 determines whether a touch signal is received from the specified regions. When a touch signal is received from the specified regions, step S6 is implemented. When no touch signal is received from the specified regions, step S4 is repeated.

In step S6, the determination module 102 determines whether a single-touch operation or a multi-touch operation is implemented. When a single-touch operation is implemented, step S8 is implemented. When a multi-touch operation is implemented, step S10 is implemented. For example, when a single touch signal is received within a predetermined time interval, the determination module 102 determines that a single-touch operation is implemented. When at least two touch signals are received within the predetermined time interval, the determination module 102 determines that a multi-touch operation is implemented.

In step S8, the response module 104 executes a response to the touch signal received from the specified regions when the single-touch operation is implemented. The response module 104 reports coordinates of the touch signal received from the specified region to a user layer of the electronic device 1.

In other embodiments, when the single-touch operation is implemented, the response module 104 may further determine whether a single-click or a double-click is implemented, and execute a response to the touch signal received from the specified regions when a double-click is implemented.

In step S10, the response module 104 ignores the touch signal received from the specified regions when the multi-touch operation is implemented, and executes a response to touch signals received from non-specified region on the touch screen 13. That is, the response module 104 executes the response to a touch event based on the touch signals received from the non-specified region, by reporting coordinates of the touch signals received from the non-specified region to the user layer of the electronic device 1.

The other layers of the electronic device 1 provide the response to the reported coordinates. For example, the electronic device may open a file, display an image, or invoke a function according to the touch signals.

In other embodiments, the response module 104 may further output a prompt to ask the user whether a mistouch occurs by displaying prompt information on a window. When the user clicks a “YES” icon in the window, the response module 104 executes step S10. When the user clicks a “NO” icon in the window, the response module 104 reports coordinates of all touch signals to the user layer.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for avoiding mistouch on a touch screen of an electronic device, the method comprising:
presetting one or more specified regions on the touch screen to avoid mistouch;
in response to receiving a touch signal in the one or more specified regions, determining whether a single-touch operation or a multi-touch operation is implemented; and
ignoring the touch signal received from the one or more specified regions when a multi-touch operation is implemented, and executing a response to touch signals received from non-specified region; or
executing a response to the touch signal received from the one or more specified regions when a single-touch operation is implemented.

2. The method according to claim 1, further comprising:
predetermining a coordinate system based on the touch screen; and
presetting coordinate ranges of the one or more specified regions.

3. The method according to claim 2, further comprising:
recording the coordinate range of the one or more specified regions in a board support package (BSP) layer of the electronic device.

4. The method according to claim 1, wherein the step of presetting one or more specified regions on the touch screen to avoid mistouch comprises:
determining a length and a width of the touch screen according to a resolution of the touch screen; and
presetting two specified regions close to two longitudinal frames of the electronic device correspondingly, lengths of the two specified regions being equal to the length of the touch screen, and widths of the two specified regions being equal to a predetermined percentage of the width of the touch screen.

5. The method according to claim 1, wherein the step of executing a response to touch signals received from non-specified region comprises:
reporting coordinates of the touch signals received from the non-specified region to a user layer of the electronic device.

6. The method according to claim 1, further comprising:
outputting a prompt to ask a user whether a mistouch occurs by displaying prompt information on a window of the touch screen; and
under the condition that the mistouch occurs, executing the step of ignoring the touch signal received from the one or more specified regions when a multi-touch operation is implemented, and executing a response to touch signals received from non-specified region; or
under the condition that no mistouch occurs, executing a response to touch signals received from the non-specified region and the one or more specified regions.

7. An electronic device, comprising:
a touch screen;
at least one processor; and
a storage device storing a plurality of instructions, which when executed by the processor, causes the at least one processor to:
preset one or more specified regions on the touch screen to avoid mistouch;
in response to receiving a touch signal in the one or more specified regions, determine whether a single-touch operation or a multi-touch operation is implemented; and
ignore the touch signal received from the one or more specified regions when a multi-touch operation is implemented, and execute a response to touch signals received from non-specified region; or
execute a response to the touch signal received from the one or more specified regions when a single-touch operation is implemented.

8. The electronic device according to claim 7, wherein the at least one processor further:
predetermines a coordinate system based on the touch screen; and
presets coordinate ranges of the one or more specified regions.

9. The electronic device according to claim 8, wherein the at least one processor further records the coordinate range of the one or more specified regions in a board support package (BSP) layer of the electronic device.

10. The electronic device according to claim 7, wherein the one or more specified regions are preset by:
determining a length and a width of the touch screen according to a resolution of the touch screen; and
presetting two specified regions close to two longitudinal frames of the electronic device correspondingly, lengths of the two specified regions being equal to the length of the touch screen, and widths of the two specified regions being equal to a predetermined percentage of the width of the touch screen.

11. The electronic device according to claim 7, wherein the at least one processor further reports coordinates of the touch signals received from the non-specified region to a user layer of the electronic device.

12. The electronic device according to claim 7, wherein the at least one processor further:
outputs a prompt to ask a user whether a mistouch occurs by displaying prompt information on a window of the touch screen; and
under the condition that the mistouch occurs, executes the step of ignoring the touch signal received from the one or more specified regions when a multi-touch operation is implemented, and executing a response to touch signals received from non-specified region; or
under the condition that no mistouch occurs, executes a response to touch signals received from the non-specified region and the one or more specified regions.

13. A non-transitory storage medium having stored thereon instructions that, when executed by a processor of an electronic device, causes the electronic device to perform a method for avoiding mistouch on a touch screen of the electronic device, the method comprising:
presetting one or more specified regions on the touch screen to avoid mistouch;
in response to receiving a touch signal in the one or more specified regions, determining whether a single-touch operation or a multi-touch operation is implemented; and
ignoring the touch signal received from the one or more specified regions when a multi-touch operation is implemented, and executing a response to touch signals received from non-specified region; or
executing a response to the touch signal received from the one or more specified regions when a single-touch operation is implemented.

14. The non-transitory storage medium according to claim 13, wherein the method further comprises:
predetermining a coordinate system based on the touch screen; and
presetting coordinate ranges of the one or more specified regions.

15. The non-transitory storage medium according to claim 14, wherein the method further comprises:
recording the coordinate range of the one or more specified regions in a board support package (BSP) layer of the electronic device.

16. The non-transitory storage medium according to claim 13, wherein the step of presetting one or more specified regions on the touch screen to avoid mistouch comprises:
determining a length and a width of the touch screen according to a resolution of the touch screen; and
presetting two specified regions close to two longitudinal frames of the electronic device correspondingly, lengths of the two specified regions being equal to the length of the touch screen, and widths of the two specified regions being equal to a predetermined percentage of the width of the touch screen.

17. The non-transitory storage medium according to claim 13, wherein the step of executing a response to touch signals received from non-specified region comprises:
reporting coordinates of the touch signals received from the non-specified region to a user layer of the electronic device.

18. The non-transitory storage medium according to claim 13, wherein the method further comprises:
outputting a prompt to ask a user whether a mistouch occurs by displaying prompt information on a window of the touch screen; and
under the condition that the mistouch occurs, executing the step of ignoring the touch signal received from the one or more specified regions when a multi-touch operation is implemented, and executing a response to touch signals received from non-specified region; or
under the condition that no mistouch occurs, executing a response to touch signals received from the non-specified region and the one or more specified regions.
